(19) United States
(12) Patent Application Publication
(10) Pub. No.: US 2008/0098700 A1
(43) Pub. Date: May 1, 2008

(54) Stirrup mounting device

(76) Inventors: Thad N. Beal, Roosevelt, UT (US); Todd Loader, Orem, UT (US); William L. Mullenbach, Las Vegas, NV (US)

Correspondence Address: THORPE NORTH & WESTERN, LLP., P.O. Box 1219, SANDY, UT, 84091-1219, US

(21) Appl. No.: 11/589,328

(22) Filed: Oct. 27, 2006

(51) Int. Cl. B68C 3/00

(52) U.S. Cl. 54/47

(57) ABSTRACT

A stirrup mounting device includes a stirrup attachment bar adapted for attachment to a stirrup strap loop extending from a saddle and a stirrup mounting bracket attached to a stirrup. The stirrup mounting bracket may be pivotally attached to the stirrup attachment bar so that the stirrup can rotate with respect to the stirrup strap loop about a vertical pivot axis. The vertical pivot axis is offset with respect to at least one of a vertical axis extending centrally through the stirrup strap loop and a vertical axis extending centrally through the stirrup so that the stirrup is offset toward the rear end of the stirrup attachment bar when the stirrup is rotated to a riding position. The stirrup mounting device can be used alone, or can be combined as part of a stirrup extender device where both the stirrup extender and the stirrup mounting device share a common stirrup attachment arm.

### BACKGROUND OF THE INVENTION

1. Field

The invention is in the field of stirrups for saddles and the mounting of the stirrups to the saddles.

2. State of the Art

Stirrups extend from a saddle to support the feet of a rider mounted in the saddle. The stirrups provide a foot receiving opening into which the foot of a rider is inserted with the foot supported by an elongate stirrup foot support defining the bottom of the foot receiving opening. The stirrup height in relation to the saddle is adjusted to fit a particular rider with the adjustment depending upon the length of the rider's legs. Stirrups are usually mounted on a saddle by looped stirrup straps mounted to opposite sides of the saddle and hanging down from the saddle to mount the stirrups. The stirrup straps are usually leather, have a width, and are arranged to hang down from the saddle with the width of the strap parallel to the saddle and to the sides of an animal on which the saddle is mounted. The stirrups are usually mounted in the stirrup strap loops by a stirrup mounting shaft which forms the top of the stirrup, which is parallel with the stirrup foot support. Such mounting of the stirrups cause the stirrups to hang with the foot receiving openings and the stirrup foot supports parallel to the animal, i.e., with the foot receiving openings facing outwardly from the side of the animal. While this orientation easily accepts the user's foot when the user faces the side of the animal for mounting the saddle on the animal, this orientation requires the rider, once the animal is mounted, to turn or twist the stirrups into riding position thereby twisting the leather stirrup strap so that the stirrup foot receiving opening faces toward the rear of the animal, not outwardly from the animal as is its normal tendency. A common practice with saddles is to form a permanent twist into the leather stirrup straps which tend to position the stirrups in riding position. However, this normally only twists the strap part of the way necessary to orient the stirrup in riding position so continuous rider twisting is still necessary to hold the stirrups in riding position. This forced twisting of the leather straps can cause ankle and knee strain for the rider. Older riders particularly may have a difficult time keeping the stirrup in a comfortable riding position without pain from the knee or ankle strain. The difficulty in keeping the stirrups in comfortable riding position makes riding difficult, uncomfortable, and sometimes impossible for older individuals.

The problem with the stirrup orientation provided by the normal stirrup mount has long been recognized. For example, U.S. Pat. Nos. 169,209 and 608,605 issued in 1875 and 1898, respectively, show rotatable stirrup mounts to allow stirrups to rotate with respect to the stirrup strap loops to riding position. A rotatable stirrup mounting device which allows a stirrup to be coupled to a stirrup strap and allows the stirrup to freely rotate in relation to the stirrup strap and saddle between a mounting orientation and riding orientation is currently being sold by Legsaver Stirrup Company of Roosevelt, Utah under the trademark LEGSAVER. A stirrup mounting bracket receives the stirrup mounting shaft and is rotatably mounted by a pivot pin to a stirrup attachment bar secured below the stirrup strap loop by an attachment bar mounting shaft that is positioned or mounted in the stirrup strap loop in the manner that the stirrup mounting shaft normally is. This device is designed to mount to the stirrup strap, which is adjusted to hold the device and the attached stirrup at a desired riding height, and to allow the stirrup to freely rotate between a mounting position and a riding position.

Other stirrup mounting devices that allow rotation of the stirrup in relation to the stirrup strap are shown in U.S. Pat. Nos. 169,209, 321,984, 396,179, 608,605, 1,174,712, 2,532,082, 5,598,687, 5,794,419, 6,216,427, and 6,220,004.

In addition to the main function of a stirrup to support a rider mounted in the saddle during riding, stirrups are also used by the rider in mounting the animal to be ridden. To do this, the rider, when standing on the ground next to the animal to be ridden, raises a foot and places the foot in the stirrup, and, using the support provided by the stirrup, raises himself or herself to a position substantially standing on the one foot in the stirrup, swings the other foot over the saddle, and sits in the saddle. However, with the stirrups adjusted to the proper height for riding, often the stirrups are not easily reached by a rider's foot from the ground. This is particularly true for a short rider with a full size animal such as a horse, or for taller riders with a tall animal, such as a tall horse. The rider cannot reach the stirrup from the ground with his or her foot to be able to mount the animal. Older riders who cannot stretch and reach as far with their feet as when younger have a similar problem reaching their leg up into the stirrup. In such instances, it is necessary to have another person available to boost the rider up to a height where the rider can place a foot into the stirrup, or to provide a support for a rider to stand on to be able to reach the stirrup.

A stirrup extender device currently being sold by E-Z Up Stirrup Extender Co., Inc. of Las Vegas, Nev. under the Trademark E-Z UP STIRRUP EXTENDER, see U.S. Pat. No. 7,073,313, has a housing which is positioned in and secured to the stirrup strap loop of a saddle with which the device is to be used and has a stirrup attachment bar extending from the housing for attaching the stirrup through a metal bracket attached to the bar which accepts the standard stirrup mounting shaft. A release button on the extender device allows the stirrup attachment bar to drop down a preset distance, such as about three inches, from a retracted position where the stirrup is at riding height to an extended position which lowers the stirrup. This allows most riders to be able to reach a stirrup that the rider otherwise has trouble reaching. The rider mounts the animal with the stirrup in extended position, and when in the saddle, pulls the stirrup and attached attachment bar upwardly with his or her toe to lock the stirrup in the retracted position which is the normally adjusted riding position for that rider. The rider can dismount with the stirrup in the retracted position or can easily reach down from the saddle to ankle position of a foot to push the release button to release the stirrup to the extended position for dismount.

Other stirrup extending devices are shown, for example, in U.S. Pat. Nos. 6,026,633, 6,173,558, 5,809,754, 5,661,957, and 5,347,797.

The extender device alone does nothing to rotate the stirrup to riding position. However, the referenced U.S. Pat. No. 7,073,313 showing the E-Z UP STIRRUP EXTENDER, shows an embodiment which is a combination of the extender and the LEGSAVER rotatable stirrup device. With such a combination, the rider has the advantage of being able to lower the stirrup and to rotate the stirrup to the most comfortable mounting orientation to mount and dismount the animal, and also to be able to raise the stirrup to riding height and to rotate the stirrup from the mounting orientation to a comfortable riding position.

While rotatable stirrup devices add to the riding comfort of a rider as far as the knee and ankle strain is concerned, it has been found that with rotatable stirrup devices, all of which have the stirrup pivot axis centered with respect to the stirrup and the stirrup mount, that when the stirrup is rotated to riding position, i.e., the stirrup rotates with respect to the stirrup attachment bar and stirrup strap so that the foot receiving opening is substantially perpendicular to the stirrup attachment bar and the orientation of the stirrup strap, the rider's lower leg and/or upper foot have a tendency to hit and rub on the rear end of the stirrup attachment bar and rear side of the stirrup strap loop. This generally is not a problem with the traditional stirrup mounting because there is no stirrup attachment bar and the stirrup strap loop rotates with the stirrup and stirrup mounting shaft so the stirrup strap loop remains parallel to the stirrup foot receiving opening. The hitting and rubbing when using a rotatable stirrup mount can be painful if the rider does not wear boots, and if the rider is wearing boots, such rubbing can scratch and damage the boots. This problem can be greater when the rotatable stirrup mounting device is used with stirrup extender devices in that the configuration of the stirrup attachment bar used with the stirrup extender device may be larger than a stirrup mounting bar used for just the rotatable stirrup mounting device. However, the problem can exist with any of the rotatable stirrup mounts, or with a nonrotatable stirrup mount such as shown in U.S. Pat. No. 6,216,427 where the stirrup is fixed in a riding position with respect to the stirrup strap.

### SUMMARY OF THE INVENTION

According to the invention, a stirrup mounting device that positions the stirrup in a rotated riding position with respect to the stirrup attachment portion of the usual stirrup strap loop without twisting of the stirrup strap loop mounts the stirrup off center with respect to the stirrup attachment portion of the stirrup strap loop to move the stirrup rearwardly with respect to the stirrup strap loop and with respect to components of the mounting device arranged substantially parallel to the stirrup attachment portion of the stirrup strap loop. This rearward offset of the stirrup offsets the rider's foot received in normal position in the stirrup from the stirrup attachment portion of the stirrup strap loop and the components parallel therewith to prevent contact between the rider's foot or footwear with the stirrup attachment portion of the stirrup strap loop and the components of the mounting device parallel therewith, such as a stirrup attachment bar attached to the stirrup attachment portion of the stirrup strap loop. In most cases, the stirrup mounting device will mount the stirrup for rotation between a mounting position and a riding position and will place the axis of rotation of the stirrup off center with respect to a stirrup attachment bar and/or a stirrup mounting bracket, both parts of the stirrup mounting device. In this way, when the stirrup is rotated to riding position, the stirrup is located away from the center of the stirrup attachment bar toward the rear end of the stirrup attachment bar. This moves a rider's foot positioned in the stirrup back from the rear end of the stirrup attachment bar, usually enough so that the rider's lower leg and/or upper foot does not hit the rear end of the stirrup attachment bar or stirrup strap loop.

It should be noted that references to offset toward the rear end of the stirrup attachment bar assumes correct positioning in the attachment of the stirrup mounting device with respect to the stirrup strap loop. The mounting device of the invention can usually be installed in one of two orientations with respect to the stirrup strap loop. One orientation will offset the stirrup rearwardly (toward the rear of the animal and toward the rider's foot when properly placed in the stirrup during normal riding) and the other orientation will offset the stirrup forwardly. The proper orientation for purposes of the invention and the language of the description and claims is the orientation that positions the offset rearwardly rather than forwardly of the stirrup strap loop. The orientation is usually changed during installation of the mounting device by rotating the device one hundred and eighty degrees with respect to the stirrup strap loop.

In one embodiment of the invention, a stirrup mounting device includes a stirrup attachment bar adapted for attachment to the usual stirrup attachment portion of the stirrup strap loop extending from a saddle. The stirrup attachment bar generally extends from attachment in the bottom of the stirrup strap loop which forms the stirrup attachment portion of the stirrup strap loop where the stirrup is usually attached, to below the stirrup strap loop and then parallel to the bottom of the stirrup strap loop. As generally positioned with a saddle mounted on an animal, the stirrup attachment portion of the stirrup strap loop has a central vertical axis extending therethrough. A stirrup mounting bracket is adapted for attachment to a stirrup, generally by attachment to the usual stirrup attachment shaft which would otherwise normally pass through the stirrup attachment portion of the stirrup strap loop to attach the stirrup to the stirrup attachment portion of the stirrup strap loop when not using the device of the invention. As generally positioned with a saddle mounted on an animal, the stirrup has a central vertical axis extending therethrough. The stirrup mounting bracket is pivotally connected to the stirrup attachment bar along a vertical pivot axis, such as formed by a pivot pin extending between the stirrup mounting bracket and the stirrup attachment bar.

In this arrangement of the invention, the vertical pivot axis of the pivotal connection of the stirrup mounting bracket to the stirrup attachment bar is offset from at least one of the strap loop stirrup attachment portion central vertical axis and the stirrup central vertical axis. With this offset, when the stirrup is rotated to riding position, the stirrup is located away from the center of the stirrup attachment bar toward the rear end of the stirrup attachment bar. This moves the rider's foot rearwardly from the rear end of the stirrup attachment bar to reduce the likelihood that a rider's leg or foot, or a rider's boot, will hit and rub against the rear end of the stirrup attachment bar. In one embodiment of the invention, the pivot axis is offset from the central vertical axes of both the strap loop stirrup attachment portion and the stirrup to increase the distance of offset of the stirrup toward the rear end of the stirrup attachment bar, thereby providing more clearance between the rear end of the stirrup attachment bar and the riders foot and leg.

Generally, with standard traditional saddles, the stirrup attachment bar will be attached to the stirrup attachment portion of the stirrup strap loop so as to hang directly below the stirrup attachment portion of the stirrup strap loop. The stirrup attachment bar will then have a center which generally will coincide with the central vertical axis through the strap loop stirrup attachment portion. Also generally, the stirrup mounting bracket will have a stirrup mounting bore therethrough adapted to receive and hold a standard stirrup mounting shaft. In the normal orientation of the device in use, the stirrup mounting bore will extend horizontally through the stirrup mounting bracket. Thus, generally, for standard traditional saddles and stirrups, the pivot connection between the stirrup attachment bar and the stirrup mounting bracket of the invention will be offset from at least one of, or offset from both of, the center of the stirrup attachment bar and the stirrup mounting bore of the stirrup mounting bracket. As indicated, this offsets the stirrup toward the rear end of the stirrup attachment bar thereby providing clearance between the rear end of the stirrup attachment bar and the rider's foot and leg.

The stirrup mounting device of the invention is also useful with the various stirrup extender devices currently available and the invention also includes the combination of the rotatable stirrup mounting device with a stirrup extender device. In such combination, the stirrup attachment bar of the stirrup attachment device of the invention may be combined with and an integral part of the stirrup attachment bar of the stirrup extender device so that the two devices become a single integrated device with a common stirrup attachment bar. Further, an animal is generally always mounted from one side, such as the left side when mounting a horse. Therefore, when using a stirrup extender device, the stirrup extender device is only necessary, and thus generally only present, on the one side of the saddle from which the animal is mounted. However, the stirrup mounting devices will be used on both sides of the saddle since the stirrup has to be rotated from its normal position as attached to the stirrup strap loop to riding position on both sides of the animal for comfortable riding. Therefore, two mounting configurations of the rotatable mounting device will normally be used on a saddle when a stirrup extender device is used.

The invention is based upon and includes the method of increasing the clearance between a rider's boot or leg and the end of a stirrup attachment bar which remains substantially parallel with the stirrup strap loop when the stirrup is in riding position substantially perpendicular to the stirrup strap loop and stirrup attachment bar, by offsetting the stirrup attachment to move the stirrup rearwardly with respect to the mounting portion of the stirrup strap loop and the center of the stirrup attachment bar.

### THE DRAWINGS

In the accompanying drawings, which show the best mode currently contemplated for carrying out the invention:

FIG. 1 is a side elevation of a rotatable stirrup mounting device of the invention mounted to a saddle stirrup strap loop, only the lower portion of the stirrup strap loop being shown, showing the stirrup in riding position with a rider's boot shown in broken lines in the normal riding position in the stirrup;

FIG. 2, a front elevation of the rotatable stirrup mounting device of FIG. 1, with the stirrup shown in mounting position aligned with the stirrup strap loop, only the lower portion of the stirrup strap loop and the upper portion of the stirrup being shown;

FIG. 3, a vertical section taken along the line 3-3 in FIG. 2; and

FIG. 4, a side elevation similar to that of FIG. 1, but showing the rotatable stirrup mounting device of the invention in combination with and as a part of a stirrup extender device, and showing the device on the opposite side of an animal to be ridden as the device shown in FIG. 1, which results in the opposite orientation of the offset and the rider's boot.

### DETAILED DESCRIPTION OF THE ILLUSTRATED EMBODIMENT

A standard traditional saddle for riding an animal such as a horse, usually includes a stirrup strap loop 10 which, when the saddle, not shown, is mounted on the animal, extends downwardly from the saddle with a stirrup attachment portion 12 at the bottom of the loop. The stirrup strap loop 10 shown is a western saddle style strap loop wherein the strap has a rearwardly extending portion 14 at the upper portion of the strap. This is not part of the stirrup attachment portion of the stirrup strap loop. In English style saddles, the strap loop is generally the same width throughout its length. The stirrup attachment portion 12 of the stirrup strap loop has a width and a central vertical axis 16. A stirrup 20 is normally attached to the stirrup attachment portion 12 of the stirrup strap loop 10. This is normally done in standard traditional saddles by passing a stirrup attachment shaft 22, which extends between the upper ends of the two sides 23 and 24 of the stirrup, through the bottom of the loop forming the stirrup attachment portion 12 of the stirrup strap loop 10. The stirrup has a central vertical axis 26. With the normal traditional mounting of the stirrup to the stirrup strap loop, the stirrup is centered with respect to the stirrup attachment portion 12 of the stirrup strap loop 10, and the stirrup strap loop vertical axis 16 and the stirrup vertical axis 26 will coincide. The central axes are referred to as vertical since in normal hanging condition of the stirrup strap loop 10 and stirrup 20, the two will hang in vertical condition. However, during use the two will move through various orientations so that the axis will not necessarily be vertical. The axes are referred to herein as vertical merely for ease of explanation.

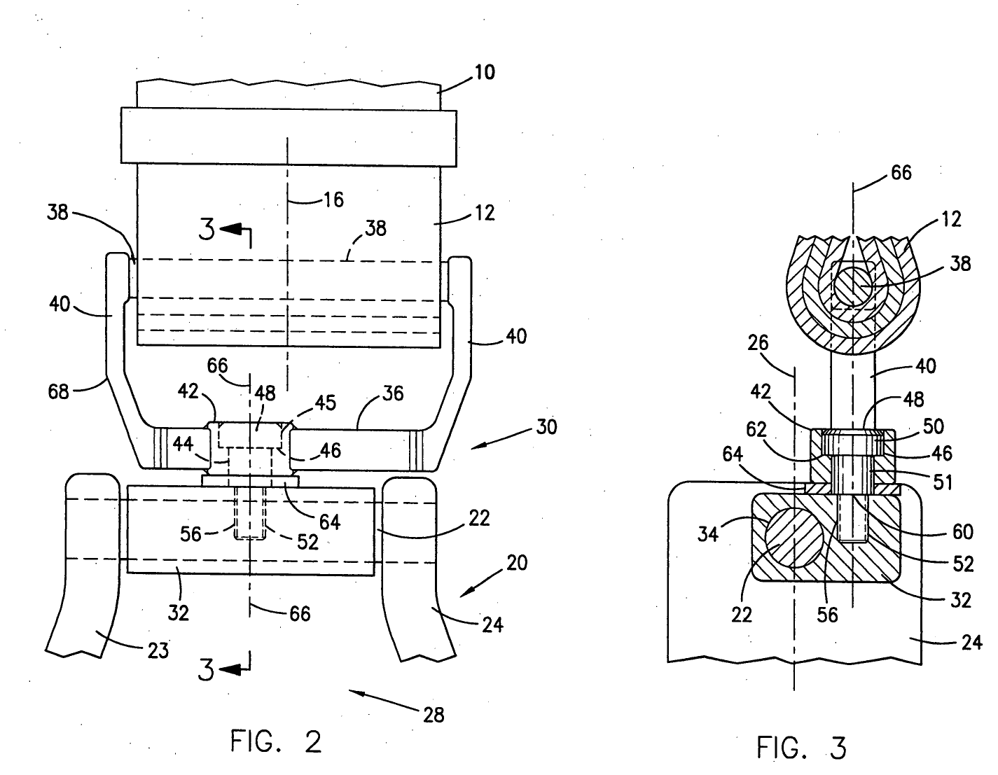

With the normal traditional mounting of the stirrup 20 to the stirrup strap loop 10 as described, the stirrup foot receiving opening 28, FIG. 2, will be aligned with and parallel to the stirrup strap 10 as shown in FIG. 2, and to the side of the animal. To turn the stirrup 10 to riding position where the stirrup foot receiving opening 28 is perpendicular to the side of the animal, the rider has to turn both the stirrup 20, the stirrup attachment shaft 22, and the stirrup attachment portion 12 of the stirrup strap loop 10 to the riding position oriented perpendicular to the side of the animal. As indicated above, this can cause ankle and knee strain to the rider. In the stirrup mounting illustrated, a rotatable stirrup mounting device 30 is positioned between the stirrup attachment portion 12 of the stirrup strap loop 10 and the stirrup attachment shaft 22 of the stirrup 20. This allows rotation of the stirrup and stirrup attachment shaft to riding position with the stirrup foot receiving opening 28 perpendicular to the side of the animal while the stirrup strap remains parallel to the side of the animal.

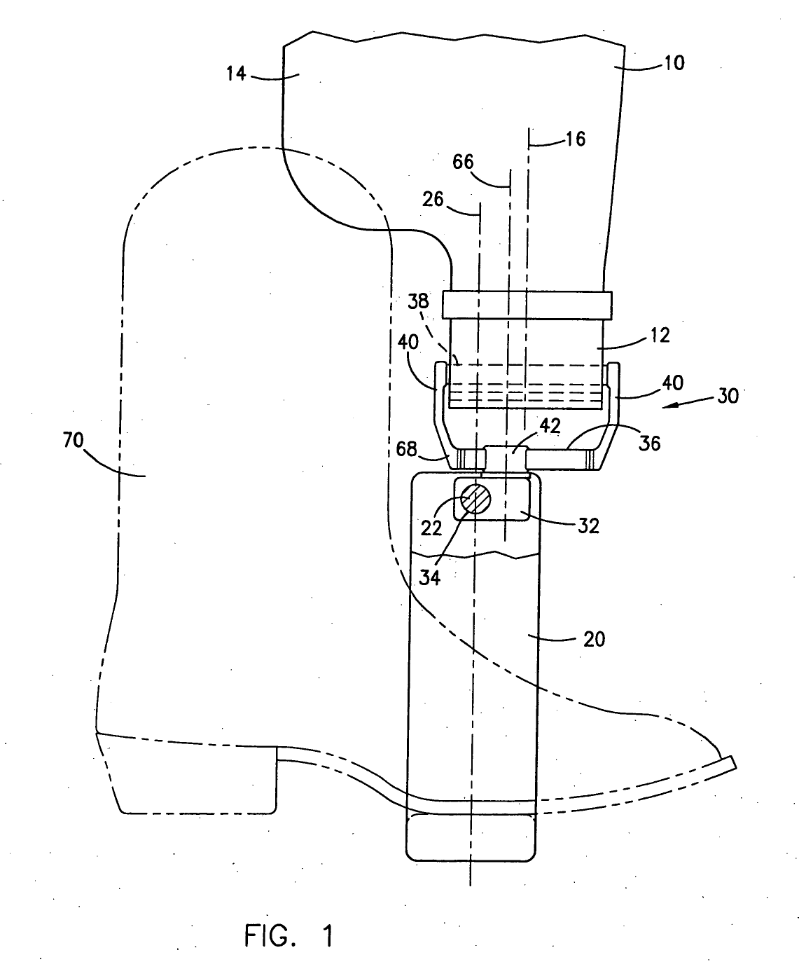

As shown, the rotatable stirrup mounting device 30, includes a stirrup mounting bracket 32 for mounting the stirrup 24 thereto. For this purpose, the illustrated stirrup mounting bracket 32 has a stirrup mounting bore 34 extending horizontally therethrough to receive and hold the stirrup attachment shaft 22. In this way, the stirrup 20 is mounted to the stirrup mounting bracket 32. The rotatable stirrup mounting device 30 also includes a stirrup attachment bar 36 attached to the stirrup attachment portion 12 of the stirrup strap loop 10. As illustrated in FIGS. 1-3, the means attaching the stirrup attachment bar 36 to the stirrup attachment portion 12 of the stirrup strap loop 10 is a horizontal member 38 secured to the stirrup attachment bar 36 and extending through the bottom of the stirrup strap loop 10. Further, as shown, the horizontal member extending through the bottom of the stirrup strap loop 10 may be part of an elongate loop or ring which includes the stirrup attachment bar 36 as part of the loop. The stirrup attachment bar 36 and the horizontal member 38 are held in spaced parallel arrangement as two sides of the loop or ring by loop end portions 40. This loop or ring can take various configurations, from the special configuration shown to merely an oval or elongate loop or ring.

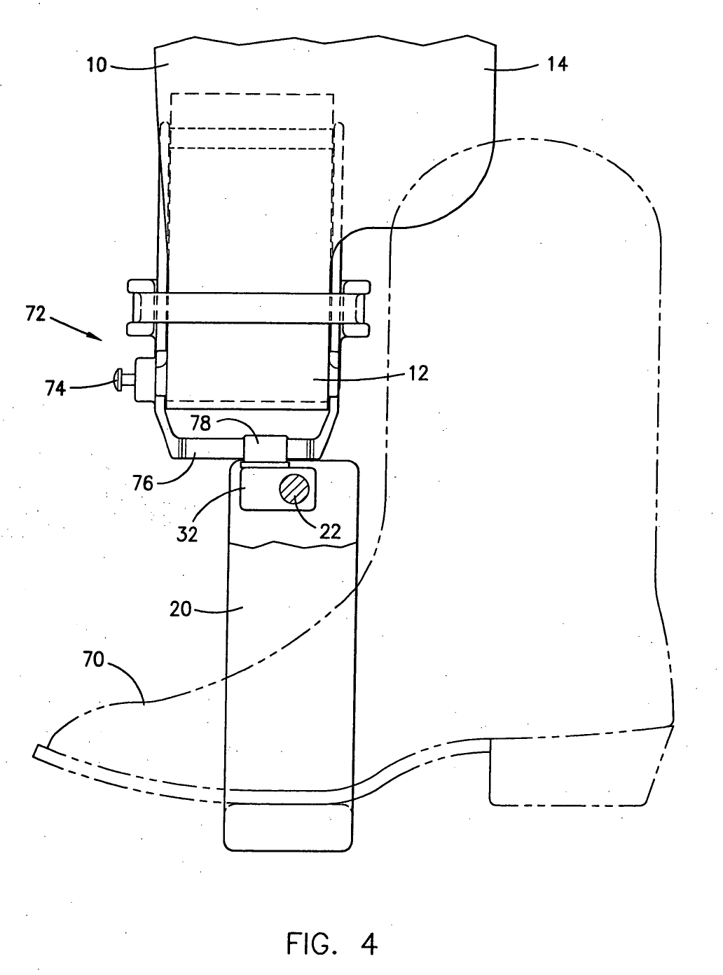

To secure the stirrup 20 to the stirrup strap loop 10, the stirrup mounting bracket 32 is pivotally attached to the stirrup attachment bar 36 so that the two can rotate with respect to one another. For this purpose, the stirrup attachment bar 36 includes a pivot pin holder 42 formed as part of the stirrup attachment bar 36 and having a pivot pin receiving hole 44, FIG. 2, extending therethrough with an enlarged top portion 45 forming a shoulder 46 between the lower portion of hole 44 and the enlarged top portion 45. A shouldered pivot pin 48, FIG. 3, having head 50, smooth intermediate portion 51, and threaded end portion 52 is screwed into threaded receiving hole 56 in stirrup mounting bracket 32. Pivot pin shoulder 60 formed between smooth intermediate portion 51 and threaded end portion 52 is tightened against the top surface of stirrup mounting bracket 32 as shown in FIG. 3. Pivot pin shoulder 62 formed between head 50 and intermediate portion 51 rotatably rests against receiving hole shoulder 46 in pivot pin holder 42 to rotatably secure pivot pin 48 in stirrup attachment bar 36. A lubricating washer 64 is positioned between pivot pin holder 42 of stirrup attachment bar 36 and stirrup mounting bracket 32. In this manner, stirrup mounting bracket 32 is pivotally attached to stirrup attachment bar 36, and can rotate with respect to stirrup attachment bar 36. Pivot pin 48 forms a vertical pivot axis 66 for rotation of stirrup mounting bracket 32 with respect to stirrup attachment bar 36. The main function of washer 64 is to restrict relative movement other than rotational movement about pivot axis 66 between stirrup mounting bracket 32 and stirrup attachment bar 36.

The pivotal attachment of stirrup mounting bracket 32 with respect to stirrup attachment bar 36 may be such as to provide unrestricted rotation of stirrup mounting bracket 32 with respect to stirrup attachment bar 36, or, if desired, the mounting may be such as to restrict rotation in some manner such as to restrict rotation to a certain angular amount, such as to ninety degrees of rotation, between the mounting position of the stirrup and the riding position of the stirrup. The pivotal attachment shown allows unrestricted rotation of stirrup mounting bracket 32 with respect to stirrup attachment bar 36. Further, if desired, provision can be made to lock the stirrup in one angular position without allowing any rotation to take place. For example, a set screw can be provided extending into the pivot pin holder 42 to intersect and be tightened against pivot pin 48 when in a desired position to prevent rotation of pivot pin 48 with respect to stirrup attachment bar 36. In this way a rider can adjust the stirrup to a comfortable riding position and lock it into this position.

In prior art rotatable stirrup mounting devices, the vertical central pivot axis 66, the strap loop stirrup attachment portion central vertical axis 16, and the stirrup central vertical axis 26 are all aligned so that the stirrup is centered below the stirrup attachment portion 12 of the stirrup strap loop 10. However, in accordance with one aspect of the current invention, the vertical pivot axis 66 is offset from one or the other or both of the strap loop stirrup attachment portion central vertical axis 16 and the stirrup vertical axis 26. FIG. 2 shows the offset between the vertical pivot axis 66 and the strap loop stirrup attachment portion central vertical axis 16. FIG. 3 shows the offset between the vertical pivot axis 66 and the stirrup vertical axis 26. FIG. 1 shows the offset between the vertical pivot axis 66 and both the strap loop stirrup attachment portion central vertical axis 16 and the stirrup vertical axis 26. As can be seen in FIG. 1, when the offsets are oriented toward the rear of the saddle, which is also toward the rear of the animal, each of the offsets will move the stirrup 20 rearwardly of the strap loop stirrup attachment portion central vertical axis 16, which moves the stirrup rearwardly in relation to the stirrup strap loop, and, importantly, in relation to the rear end 68 of the stirrup attachment bar 36. As shown in FIG. 1, this provides clearance between the rear end 68 of the stirrup attachment bar 36 and a rider's boot 70. When all axes are aligned, as in the prior art, the stirrup is often positioned with respect to the rear end of the stirrup attachment bar so that the rider's boot has a tendency to hit and scrape on the rear end 68 of the attachment bar or, if the rider is not wearing boots, for the rider's lower leg and/or upper foot (usually the rider's shins) to hit and rub on the rear end 68 the attachment bar and/or the rear edge of the stirrup strap loop 10. While particular offsets are shown in the drawings, the amount of these offsets many be increased or decreased as desired to provided desired offsets of the stirrup behind the stirrup attachment bar and stirrup strap loop. For example, to increase the offset of the vertical pivot axis 66 with respect to the strap loop stirrup attachment portion central vertical axis 16, the pivot pin holder 42, and thus the pivot pin 48 and the vertical pivot axis 66 can be moved to the left in FIG. 2 to further offset the vertical pivot axis 66 from the center of the stirrup attachment bar 36 and the strap loop stirrup attachment portion central vertical axis 16. If all of the offset is to be provided by the stirrup mounting bracket, the pivot pin holder 42 and the pivot pin 48 may be centered along the stirrup attachment bar 36 which will generally align the vertical pivot axis with the strap loop stirrup attachment portion central vertical axis 16.

In the embodiment shown, the stirrup mounting bracket 32 has a rectangular shape with a wide side and a narrow side. The stirrup mounting bore 34 is not centered with respect to the width (wide side) of the stirrup mounting bracket 32, but extends through the stirrup mounting bracket closer to one narrow side than the other. The pivot pin receiving hole 56 in the stirrup mounting bracket 32 also is not centered with respect to the width (wide side) of the stirrup mounting bracket 32, but extends into the stirrup mounting bracket closer to the opposite narrow side. This positions the stirrup mounting bore 34 offset from the center of the width to one side of the bracket width and the pivot pin receiving hole 56 offset from the center of the width to the other side of the bracket width. Thus, in the normal orientation of the device in use, as shown in FIGS. 1, 3, and 4, the stirrup mounting bracket will be pivotally attached to the stirrup attachment bar so that the vertical pivot axis 66 is offset from the stirrup mounting bore 34 and the stirrup central vertical axis 26. If all of the offset is to be provided by the stirrup attachment bar 36, the pivot pin receiving hole 56 and the stirrup mounting bore 34 may be aligned vertically in the stirrup mounting bracket 32.

The pivot pin receiving hole 56 in the stirrup mounting bracket 32, although offset widthwise as explained above and as shown in FIG. 3, will generally be centered lengthwise along the length of the stirrup mounting bracket 32 as shown in FIG. 2. This will offset the stirrup with respect to the stirrup attachment portion 12 of the stirrup strap loop 10 to the same extent as the offset of the pivot pin 48 and pivot axis 66 with respect to the stirrup attachment portion 12 of the stirrup strap loop 10 when the stirrup is in mounting position shown in FIG. 2. This does not affect the mounting of the animal. Advantageously, however, this will keep the stirrup similarly positioned with respect to the side of the animal as with traditional saddles when the stirrup is in riding position. If, for some reason, it is desired to offset the stirrup in riding position either closer to the animal or further from the animal than with traditional saddles, the pivot pin receiving hole 56 can be offset along the length of the stirrup mounting bracket 32. For example, the pivot pin receiving hole 56 could be offset the same amount as the pivot pin is offset along the stirrup attachment bar. This would center stirrup 20 in the mounting position of FIG. 2 with the stirrup attachment portion 12 of the stirrup strap loop 10 and the stirrup attachment bar 36, but as the stirrup is rotated into riding position, would offset or space the stirrup outwardly away from the side of the animal further than with traditional saddles. Various other offsets of the stirrup inwardly or outwardly from the side of the animal and with respect to the strap loop stirrup attachment portion central vertical axis 16 when the stirrup is in riding position can be provided by movement of the pivot pin receiving hole 56 along the length of the stirrup mounting bracket.

The rotatable stirrup mounting device of the invention can be combined with a stirrup extender device to provide the advantages of the stirrup extender device with the benefits of the rotatable stirrup mounting device. The combined benefits make it much easier and much more comfortable for older riders to continue riding. FIG. 4 shows a rotatable stirrup mounting device of the invention mounted as part of a stirrup extender device to provide the combination device of the invention. A stirrup extender device, indicated generally as 72, is shown mounted in the stirrup strap loop 10 in usual manner for the stirrup extender device. While various embodiments of stirrup extender devices can be used, the stirrup extender device shown in FIG. 4 is the device shown in U.S. Pat. No. 7,073,313, which is incorporated herein by reference. When mounted in the stirrup strap loop 10 as shown, the stirrup extender device 70 can hold the stirrup 20 at riding height with respect to the stirrup strap loop 10 as shown, or can be operated by depressing button 74, to extend the stirrup about three inches lower than riding position to a mounting position to make it easier for a rider to reach the stirrup for mounting the animal to be ridden. The stirrup extender device includes a stirrup attachment bar 76 which is adapted to mount a stirrup thereto. This mounting is normally through a stirrup mounting bracket which does not provide for rotation of the stirrup, or for only very limited rotation of the stirrup, between mounting position and riding position. When mounting the stirrup for full rotation using a rotatable stirrup mounting device, the rotatable stirrup mounting device is separately mounted to the stirrup attachment bar as shown and described in cited U.S. Pat. No. 7,073,313. In addition, the separate mounting centers the stirrup with the stirrup attachment portion 12 of the stirrup strap loop 10.

In the embodiment shown in FIG. 4, the stirrup attachment bar 76 of the stirrup extension device 72 also forms the stirrup attachment bar of the rotatable stirrup mounting device. This can be accomplished by forming a pivot pin holder 78, similar to pivot pin holder 42 of FIGS. 1-3, as part of stirrup attachment bar 76, as shown. Stirrup mounting bracket 32 with stirrup 20 mounted thereto by stirrup attachment shaft 22 as described for the embodiment of FIGS. 1-3, is pivotally mounted to stirrup attachment bar 76 as described for the attachment to stirrup attachment bar 36 of FIGS. 1-3. This provides a single combined stirrup extender with rotatable stirrup. The provision of the single combined attachment bar is also advantageous in that it reduces the mounting distance of the stirrup below the bottom of the stirrup strap loop 10 over that when a separate rotatable stirrup mounting device is secured to the stirrup extension device as shown in cited U.S. Pat. No. 7,073,313.

It is preferred in such single combined stirrup extender with rotatable stirrup that the pivotal mounting of the stirrup mounting bracket to the stirrup attachment bar include the offsetting features of the stirrup with respect to the strap loop stirrup attachment portion central vertical axis as described above. The offset pivotal mounting of the stirrup mounting bracket 32 to the stirrup attachment bar 76 will be as described above for the attachment of the of the stirrup mounting bracket 32 to the stirrup attachment bar 36. The details of this mounting are not repeated here.

An animal is generally always mounted from one side, such as from the left side when mounting a horse. Therefore, when using the combined stirrup extender with rotatable stirrup, the combined stirrup extender with rotatable stirrup is only necessary, and thus generally only used, on the one side of the saddle from which the animal is mounted. Therefore, as illustrated in FIG. 4, the combined stirrup extender with rotatable stirrup is used on the left side of the saddle. As illustrated in FIG. 1, the rotatable stirrup mounting device will be directly mounted to the stirrup strap on the right side of the saddle. The stirrup orientation and the boot orientation will appear opposite when looking toward the animal from opposite sides. If a stirrup extender is not used, both sides of the saddle will use the rotatable stirrup mounting device as shown in FIGS. 1-3. When supplying the rotatable stirrup device to a rider, if the rider wants a stirrup extender device, the rider will be supplied with one combination device as shown in FIG. 4 and one device as shown in FIG. 1. If the rider does not want the stirrup extender feature, but only the rotatable stirrup feature, the rider will be supplied with two of the devices as shown in FIG. 1.

When supplying the rotatable stirrup mounting device as part of a stirrup extender device as shown in FIG. 4, it is aesthetically pleasing to make the stirrup attachment bar and loop of the device of FIG. 1, which is used without the stirrup extender device, similar in configuration to the stirrup attachment bar of the stirrup extender device of FIG. 4. Thus, as shown in FIGS. 1 and 4, the stirrup attachment bars 36 and 78, respectively, and the associated loop ends 40, FIG. 1, joining the horizontal member 38 and completing the loop arrangement, have the same configuration as the stirrup attachment bar and ends of the stirrup extender device, FIG. 4. However, any configuration for the stirrup attachment bar 36 and the means for attaching the stirrup attachment bar to the stirrup attachment portion 12 of the stirrup strap loop 10, such as any configuration of the horizontal bar 38 and loop ends 40, can be used. These can merely take the form of an oval or flattened loop or ring, or can take various forms other than loops. Any means of attaching the stirrup attachment bar to the stirrup attachment portion 12 of the stirrup strap loop 10 can be used, and the stirrup attachment bar can take various form to provide a pivotal attachment to the stirrup mounting bracket.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

1. A stirrup mounting device, comprising:
a stirrup attachment bar adapted for attachment to a stirrup attachment portion of a stirrup strap loop extending from a saddle, the stirrup attachment portion of the stirrup strap loop having a strap loop stirrup attachment portion central vertical axis, and the stirrup attachment bar extending horizontally in a vertical stirrup attachment bar plane;
a stirrup mounting bracket adapted for attachment to a stirrup having a stirrup attachment shaft which extends horizontally in a vertical stirrup attachment shaft plane, the stirrup having a stirrup central vertical axis; and
a pivot connection rotatably mounting the stirrup mounting bracket to the stirrup attachment bar about a vertical pivot axis, said vertical pivot axis being located in relation to the stirrup attachment bar and the stirrup mounting bracket so that when the stirrup attachment bar is attached to the stirrup strap loops and the stirrup is attached to the stirrup mounting bracket, and the vertical stirrup attachment bar plane and the vertical stirrup attachment shaft plane are substantially parallel, the respective vertical planes are offset with respect to one another.

2. A stirrup mounting device according to claim 1, wherein the vertical pivot axis is offset with respect to the strap loop stirrup attachment portion central vertical axis.

3. A stirrup mounting device according to claim 1, wherein the vertical pivot axis is offset with respect to the stirrup attachment shaft central vertical axis.

4. A stirrup mounting device according to claim 1, wherein the vertical pivot axis is offset with respect to both of the strap loop stirrup attachment portion central vertical axis and the stirrup attachment shaft central vertical axis.

5. A stirrup mounting device according to claim 1, wherein the stirrup mounting bracket is adapted to receive and attach a stirrup mounting shaft positioned at an upper end of the stirrup.

6. A stirrup mounting device according to claim 1, wherein the pivot connection includes a pivot pin received in a receiving hole in the stirrup attachment bar and a receiving hole in the stirrup mounting bracket.

7. A stirrup mounting device according to claim 1, wherein the stirrup attachment bar includes means adapted for attachment to the stirrup attachment portion of the stirrup strap loop.

8. A stirrup mounting device according to claim 7, wherein the means adapted for attachment of the stirrup attachment bar to the stirrup attachment portion of the stirrup strap loop is adapted to attach the stirrup attachment bar to the bottom of a stirrup extender device mounted in the stirrup attachment portion of the stirrup strap loop.

9. A stirrup mounting device according to claim 24, wherein the stirrup extender device moves the stirrup attachment bar between a riding position wherein the stirrup attachment bar is positioned a first distance below the stirrup strap loop, and an extended position wherein the stirrup attachment bar is positioned a second distance below the stirrup strap loop.

10. A stirrup mounting device according to claim 24, wherein the stirrup extender device positions the stirrup attachment bar below the stirrup strap loop.

11. A stirrup mounting device according to claim 25, wherein the stirrup extender device moves the stirrup attachment bar between a riding position wherein the stirrup attachment bar is positioned a first distance below the stirrup strap loop, and an extended position wherein the stirrup attachment bar is positioned a second distance below the stirrup strap loop.

12. A stirrup mounting device according to claim 7, wherein the means for attachment of the stirrup attachment bar to the stirrup attachment portion of the stirrup strap loop includes a member adapted to extend through the stirrup attachment portion of the stirrup strap loop.

13. A stirrup mounting device according to claim 12, wherein the stirrup attachment bar is a portion of a loop including the member to extend through the stirrup attachment portion of the stirrup strap loop.

14. A stirrup mounting device according to claim 13, wherein the stirrup attachment bar is part of an elongate ring.

15. A stirrup mounting device, comprising:
a stirrup attachment bar adapted for attachment to a stirrup strap loop extending from a saddle;
a stirrup mounting bracket having a stirrup mounting bore therethrough adapted to receive a stirrup attachment shaft for mounting a stirrup to the stirrup mounting bracket; and
a pivot connection rotatably mounting the stirrup mounting bracket to the stirrup attachment bar, said pivot connection being located off center in relation to the stirrup mounting bracket.

16. A stirrup mounting device according to claim 23, wherein the stirrup attachment bar has a length with a center, wherein the pivot connection includes a pivot pin receiving hole in the stirrup attachment bar, and wherein the pivot pin receiving hole in the stirrup attachment bar is offset from the center of the stirrup attachment bar.

17. A stirrup mounting device according to claim 16, wherein the stirrup mounting bracket has a width with a center, and the pivot pin receiving hole is offset from the center of the width.

18. A stirrup mounting device according to claim 23, wherein the stirrup mounting bracket has a width with a center, and the pivot pin receiving hole is offset from the center of the width.

19. A stirrup mounting device according to claim 15, wherein the stirrup attachment bar is a portion of a ring mounted in and hanging down from the stirrup strap loop and includes a pivot pin receiving hole therein.

20. (canceled)

21. (canceled)

22. (canceled)

23. A stirrup mounting device according to claim 15, wherein the pivot connection includes a pivot pin and a pivot pin receiving hole in the stirrup mounting bracket.

24. A stirrup mounting device, comprising:
a stirrup extender device adapted for attachment to a stirrup attachment portion of a stirrup strap loop extending from a saddle, the stirrup extender device having a stirrup attachment bar extending horizontally in a vertical stirrup attachment bar plane;
a stirrup mounting bracket adapted for attachment to a stirrup having a stirrup attachment shaft which extends horizontally in a vertical stirrup attachment shaft plane; and
a pivot connection rotatably mounting the stirrup mounting bracket to the stirrup attachment bar about a vertical pivot axis, said vertical pivot axis being located in relation to the stirrup attachment bar and the stirrup mounting bracket so that when the stirrup attachment bar is attached to the stirrup strap loops and the stirrup is attached to the stirrup mounting bracket, and the vertical stirrup attachment bar plane and the vertical stirrup attachment shaft plane are substantially parallel, the respective vertical planes are offset with respect to one another.

25. A stirrup mounting device, comprising:
a stirrup extender device adapted for attachment to a stirrup attachment portion of a stirrup strap loop extending from a saddle, the stirrup extender device having a stirrup attachment bar;
a stirrup mounting bracket having a stirrup mounting bore therethrough adapted to receive a stirrup attachment shaft for mounting a stirrup to the stirrup mounting bracket; and
a pivot connection rotatably mounting the stirrup mounting bracket to the stirrup attachment bar, said pivot connection being located off center in relation to the stirrup mounting bracket.
